(19) United States
(12) Patent Application Publication
(10) Pub. No.: US 2025/0317996 A1
(43) Pub. Date: Oct. 9, 2025

(54) METHOD AND APPARATUS FOR HETEROGENEOUS NETWORK SELECTION CONTROL

(71) Applicant: Samsung Electronics Co., Ltd., Gyeonggi-do (KR)

(72) Inventors: Dongeun SUH, Gyeonggi-do (KR); Youngkyo BAEK, Gyeonggi-do (KR); Hoyeon LEE, Gyeonggi-do (KR)

(21) Appl. No.: 19/170,517

(22) Filed: Apr. 4, 2025

(30) Foreign Application Priority Data
Apr. 4, 2024 (KR) 10-2024-0046220
Apr. 8, 2024 (KR) 10-2024-0047467

(51) Int. Cl. H04W 76/10; H04L 45/745; H04W 40/02; H04W 60/00

(52) U.S. Cl. CPC H04W 76/10; H04L 45/745; H04W 40/02; H04W 60/00

(57) ABSTRACT

Provided is a 5^{th}-generation (5G) or 6^{th}-generation (6G) communication system for supporting a higher data transmission rate. A method performed by a user equipment (UE) in a wireless communication system is provided. The method includes transmitting, to an access and mobility management function (AMF), a registration request message including information indicating that the UE supports a non-3rd generation partnership project (3GPP) access without non-access stratum (NAS), receiving, from the AMF, user equipment route selection policy (URSP) rule information including a route selection descriptor associated with the non-3GPP access without NAS, and transmitting, to the AMF, a session establishment request message including information on a capability of the non-3GPP access without NAS.

### CROSS-REFERENCE TO RELATED APPLICATIONS

This application is based on and claims priority under 35 U.S.C. § 119 to Korean Patent Application Nos. 10-2024-0046220 and 10-2024-0047467, which were filed in the Korean Intellectual Property Office on Apr. 4, 2024 and Apr. 8, 2024, respectively, the disclosures of which are incorporated herein by reference in their entireties.

### BACKGROUND

### 1. Field

The disclosure relates generally to a wireless communication system, and more particularly, to a heterogeneous network selection control method and apparatus in the wireless communication system.

### 2. Description of Related Art

The 5th-generation (5G) mobile communication technology defines a wide frequency band to allow high transmission speed and new service and may also be implemented in an ultra-high frequency above the 6 gigahertz (GHz) band, referred to as millimeter wave (mmWave) bands, such as 28 GHz and 39 GHz bands and a below 6 GHz frequency referred to as sub 6 GHz bands such as 3.5 GHZ. In the 6th-generation (6G) mobile communication technology referred to as the beyond 5G system, implementation in the terahertz (THz) band such as 95 GHz to 3 THz bands is being considered to achieve a transmission speed that is 50 times the transmission speed of the 5G mobile communication technology and an ultra-low delay time that is one tenth of the delay time of the 5G mobile communication technology.

Since the early stage of the 5G mobile communication technology, to support services and satisfy performance requirements for enhanced mobile broadband (eMBB), ultra-reliable low-latency communications (URLLC), and massive machine-type communications (mMTC), standardization has been performed on beamforming and massive MIMO for mitigating the path loss of radio waves in the ultra-high frequency band and increasing the propagation distance of radio waves, support of various numerologies (operation of multiple subcarrier intervals and the like) and dynamic operation of slot formats for efficient utilization of ultra-high frequency resources, initial access technology for supporting multi-beam transmission and broadband, definition and operation of bandwidth parts (BWPs), new channel coding methods such as low-density parity check (LDPC) codes for large-capacity data transmission and polar codes for reliable transmission of control information, layer 2 (L2) preprocessing, network slicing for providing dedicated networks specialized for particular services, and the like.

Currently, by considering services that the 5G mobile communication technology was intended to support, discussion for initial 5G mobile communication technology improvement and enhancement has been performed, and physical layer standardization for technologies such as vehicle-to-everything (V2X) for assisting the driving determination of autonomous vehicles and increasing the convenience of users based on the position and state information transmitted by the vehicles, new radio unlicensed (NR-U) for system operations meeting various regulation requirements in unlicensed bands, NR terminal low power consumption technology (user equipment (UE) power saving), non-terrestrial network (NTN) that is terminal-satellite direct communication for securing a coverage in an area where communication with a terrestrial network is impossible, and positioning has been performed.

In addition, standardization of wireless interface architectures/protocols for technologies such as industrial Internet of things (IIoT) for supporting new services through linkage and integration with other industries, integrated access and backhaul (IAB) for providing nodes for expanding network service areas by integrating a wireless backhaul link and an access link, mobility enhancement including conditional handover and dual active protocol stack (DAPS) handover, and two-step random access channel (2-step RACH) for new radio (NR) for simplifying a random access procedure has also been performed, and standardization of system architectures/services for 5G service-based architecture and interface for grafting network function virtualization (NFV) and software-defined networking (SDN) technology, mobile edge computing (MEC) for providing services based on the position of terminals, and the like has also been performed.

When such 5G mobile communication systems are commercialized, a significant increase in devices connected to the communication network is anticipated. Accordingly, it is expected to require enhanced functions and performance of the 5G mobile communication system and integrated operation of connected devices. For this purpose, new research will be conducted on extended reality (XR) for efficiently supporting augmented reality (AR), virtual reality (VR), mixed reality (MR), and the like, 5G performance improvement and complexity reduction utilizing artificial intelligence (AI) and machine learning (ML), AI service support, metaverse service support, drone communication, etc.

The development of the 5G mobile communication systems may serve as a basis for the development of not only multi-antenna transmission technologies such as new waveform, full dimensional MIMO (FD-MIMO), array antenna, and large scale antenna for ensuring the coverage in the terahertz band of the 6G mobile communication technology, high-dimensional spatial multiplexing technologies using metamaterial-based lenses and antennas and orbital angular momentum (OAM) to improve the coverage of terahertz band signals, and reconfigurable intelligent surface (RIS) technologies, but also full duplex technologies for improving the frequency efficiency and system network of the 6G mobile communication technology, AI-based communication technologies utilizing satellites and AI from the design stage and embedding an end-to-end AI support function to realize system optimization, next-generation distributed computing technologies for realizing services with complexity beyond the limit of the terminal operation capability by utilizing ultrahigh-performance communication and computing resources, and the like.

As various services may be provided due to the development of wireless communication systems described above, there is a need in the art for schemes for controlling sessions in multi-access environments.

### SUMMARY

The disclosure has been made to address at least the above-mentioned problems and/or disadvantages and to provide at least the advantages described below.

Accordingly, an aspect of the disclosure is to provide a UE operating method including transmitting a registration request message to an access and mobility management function (AMF), receiving a UE policy from a policy control function (PCF), and transmitting a protocol data unit (PDU) session establishment request message to the AMF based on the UE policy.

In accordance with an aspect of the disclosure, a method performed by a user equipment (UE) in a wireless communication system is provided. The method includes transmitting, to an access and mobility management function (AMF), a registration request message including information indicating that the UE supports a non-3rd generation partnership project (3GPP) access without non-access stratum (NAS), receiving, from the AMF, user equipment route selection policy (URSP) rule information including a route selection descriptor associated with the non-3GPP access without NAS, and transmitting, to the AMF, a session establishment request message including information on a capability of the non-3GPP access without NAS.

In accordance with an aspect of the disclosure, a method performed by an access and management function (AMF) in a wireless communication system is provided. The method includes receiving, from a user equipment (UE), a registration request message including information indicating that the UE supports a non-3rd generation partnership project (3GPP) access without non-access stratum (NAS), transmitting, to the UE, user equipment route selection policy (URSP) rule information including a route selection descriptor associated with the non-3GPP access without NAS, and receiving, from the UE, a session establishment request message including information on a capability of the non-3GPP access without NAS.

In accordance with another aspect of the disclosure, a user equipment (UE) in a wireless communication system is provided. The UE includes a transceiver, a processor, wherein the processor is configured to transmit, to an access and mobility management function (AMF) via the transceiver, a registration request message including information indicating that the UE supports a non-3rd generation partnership project (3GPP) access without non-access stratum (NAS), receive, from the AMF via the transceiver, user equipment route selection policy (URSP) rule information including a route selection descriptor associated with the non-3GPP access without NAS, and transmit, to the AMF via the transceiver, a session establishment request message including information on a capability of the non-3GPP access without NAS.

In accordance with another aspect of the disclosure, an access and management function (AMF) in a wireless communication system is provided. The AMF includes a transceiver, a processor, wherein the processor is configured to receive, from a user equipment (UE) via the transceiver, a registration request message including information indicating that the UE supports a non-3rd generation partnership project (3GPP) access without non-access stratum (NAS), transmit, to the UE via the transceiver, user equipment route selection policy (URSP) rule information including a route selection descriptor associated with the non-3GPP access without NAS, and receive, from the UE via the transceiver, a session establishment request message including information on a capability of the non-3GPP access without NAS.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an architecture of a 5G system according to an embodiment;

FIG. 2 illustrates a method of transmitting non-3^{rd} generation partnership project (3GPP)-related control information as terminal configuration information according to an embodiment;

FIG. 3 illustrates a method of transmitting a UE route selection policy (URSP) rule as terminal configuration information according to an embodiment;

FIG. 4 is a diagram illustrating an internal structure of a UE, according to an embodiment; and

FIG. 5 is a diagram illustrating an internal structure of a base station, according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

The terms used herein are those general terms currently widely used in the art in consideration of functions in the disclosure, but the terms may vary according to the intentions of those of ordinary skill in the art, precedents, or new technology in the art. In some cases, there may be terms that are optionally selected, and the meanings thereof will be described in detail in the corresponding portions of the disclosure. Thus, the terms used herein should be understood not as simple names but based on the meanings of the terms and the overall description of the disclosure.

Throughout the disclosure, when something is referred to as “including” an element, one or more other elements may be further included unless otherwise specified. As used herein, the terms such as “units” and “modules” may refer to units that perform at least one function or operation, and the units may be implemented as hardware or software or a combination of hardware and software.

The expression “at least one of A, B, and C” may refer to any one of “A”, “B”, “C”, “A and B”, “A and C”, “B and C”, and “A, B, and C”.

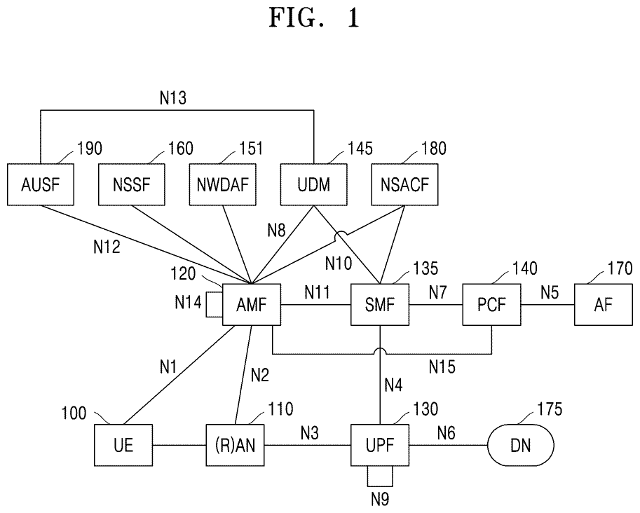

FIG. 1 illustrates an architecture of a 5G system according to an embodiment.

Referring to FIG. 1, a 5G mobile communication network may include, but is not limited to, a 5G UE (or a terminal) 100, a 5G radio access network (RAN) 110 (or a base station, a 5G nodeB (gNB), an evolved nodeB (eNB), etc.), and a 5G core network.

The 5G core network may include network functions (NFs) such as an AMF 120 providing a UE mobility management function, a session management function (SMF) 135 providing an SMF, a user plane function (UPF) 130 performing a data transmission function, a PCF 140 providing a PCF, a unified data management (UDM) 145 providing a data management function such as subscriber data and policy control data, and a unified data repository (UDR) storing data of various NFs such as UDM.

The 5G core network may further include NFs such as a network slice selection function (NSSF) 160, a network data analytic function (NWDAF) 151, an application function (AF) 170, a data network (DN) 175, and a network slice admission control function (NSACF) 180. However, the disclosure is not limited thereto.

In the 3GPP system, a conceptual link connecting NFs to each other in the 5G system may be defined as a reference point.

The following may be examples of the reference points included in the 5G system architecture represented in FIG. 1.

N1 is a reference point between UE 100 and AMF 120.

N2 is a reference point between radio access network and/or access network ((R)AN) 110 and AMF 120.

N3 is a reference point between (R)AN 110 and UPF 130.

N4 is a reference point between SMF 135 and UPF 130.

N5 is a reference point between PCF 140 and AF 170.

N6 is a reference point between UPF 130 and DN 175.

N7 is a reference point between SMF 135 and PCF 140.

N8 is a reference point between UDM 145 and AMF 120.

N9 is a reference point between two core UPFs 130.

N10 is a reference point between UDM 145 and SMF 135.

N11 is a reference point between AMF 120 and SMF 135.

N12 is a reference point between AMF 120 and authentication server function (AUSF) 190.

N13 is a reference point between UDM 145 and AUSF 190.

N14 is a reference point between two AMFs 120.

N15 is a reference point between PCF 140 and AMF 120 in a non-roaming scenario or between PCF 140 and AMF 120 in a visited network in roaming scenario.

In the 5G system, network slicing may refer to a technology and structure that enables multiple virtualized independent logical networks in a single physical network. To satisfy the specialized requirements of a service/application, a network operator may configure a virtual end-to-end network referred to as a network slice to provide a service. In this case, the network slice may be distinguished by an identifier referred to as single-network slice selection assistance information (S-NSSAI).

The network may transmit a set of allowed slices (e.g., allowed NSSAI(s)) to the terminal in a terminal registration procedure (e.g., UE registration procedure), and the terminal may transmit/receive application data through a PDU session generated through one of the S-NSSAIs (i.e., a network slice).

Hereinafter, an operation of an NF may be understood as an operation of an orchestration and management.

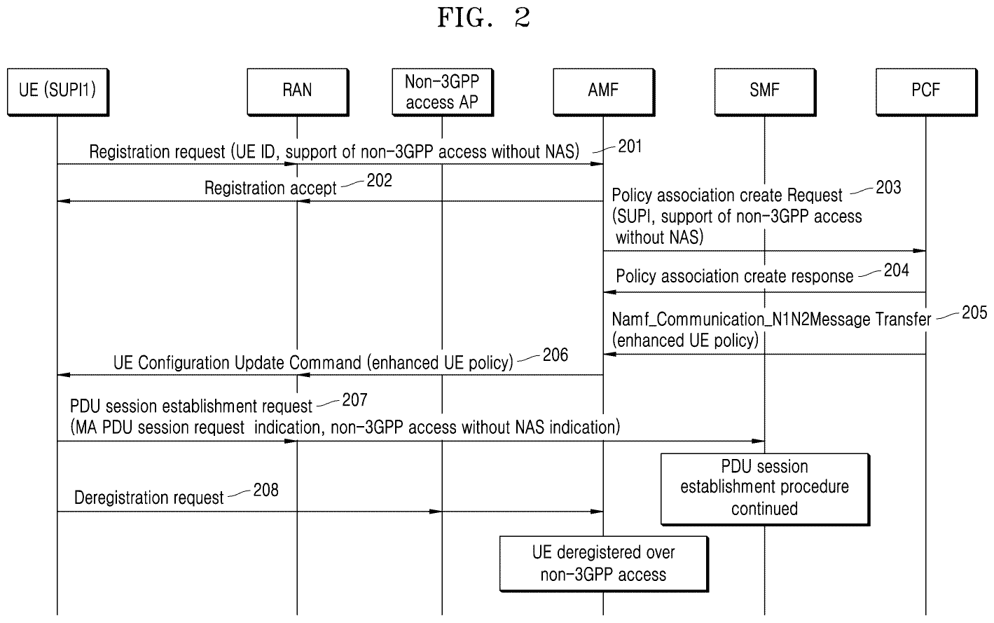

FIG. 2 illustrates a method of transmitting non-3GPP-related control information as terminal configuration information according to an embodiment.

Herein, instead of non-3GPP access without network attached storage (NAS), lightweight non-3GPP access, lightweight access traffic steering, switching, and splitting (ATSSS), ATSSS with non-3GPP access without NAS, or the like may be used with the same meaning.

Referring to FIG. 2, in step 201, the UE may transmit a registration request message to the AMF through the RAN.

When the UE supports non-3GPP access without a control signaling path (e.g., N2 interface or N1 interface), the UE may include an indicator indicating support (e.g., support of non-3GPP access without NAS) in the registration request message. However, the disclosure is not limited thereto.

The UE may include a UE identifier (ID) based on a subscription permanent identifier (SUPI) in a response request message. However, the disclosure is not limited thereto.

In step 202, when the AMF receives the registration request message from the UE, the AMF may determine whether to allow UE registration based on subscription information of the UE.

The AMF may transmit a registration accept message to the UE through the RAN.

In step 203, the AMF may transmit a policy association establishment request message to the PCF.

When the registration request message received from the UE includes support of non-3GPP access without NAS, the AMF may include support of non-3GPP access without NAS in the policy association establishment request message transmitted to the PCF.

The policy association establishment request message transmitted by the AMF to the PCF may include, but is not limited to, a UE ID (e.g., SUPI).

In step 204, the PCF may transmit, to the AMF, a response message including the result (success or failure) of the UE policy association establishment request message received from the AMF.

In step 205, when the PCF accepts the UE policy association establishment in step 204, the PCF may transmit the UE policy through the AMF to the UE through a UE configuration update procedure.

When the UE supports non-3GPP access without NAS, the PCF may include the following information in a message transmitted to the AMF.

The following information may be transmitted in a transparent container (e.g., a UE policy container) transmitted to the UE.

Non-3GPP access without NAS allowed indication: When the UE is allowed to use non-3GPP access without NAS (i.e., to directly transmit traffic to an ATSSS proxy (or UPF) through a non-3GPP access point), this information may be included in the transparent container. The information may be present for each public land mobile network (PLMN).

Non-3GPP access preference: When the UE is allowed to use non-3GPP access without NAS, the transparent container may include information indicating which access the UE will preferentially use between non-3GPP access without NAS and legacy non-3GPP access (e.g., to perform registration through non-3GPP access, establish a session with an ATSSS proxy (or UPF) through a non-3GPP access point and a non-3GPP interworking function (N3IWF), and transmit traffic).

For example, one of the following modes may be provided.

Legacy non-3GPP access first: Use legacy non-3GPP access preferentially and use non-3GPP access without NAS only when NAS is not usable

Non-3GPP access without NAS first: Use non-3GPP access without NAS preferentially and use legacy non-3GPP access only when NAS is not usable

Non-3GPP access without NAS only when roaming: Use non-3GPP access without NAS only when roaming

The above information may be provided for each PLMN. Additionally, the above information may be provided for each S-NSSAI and/or Data Network Name (DNN).

In step 206, the AMF may receive a message of step 205, and when a transparent container to be transmitted to the UE is in the message, the AMF may transmit the information to the UE through the RAN.

When the message received from the AMF through the RAN includes configuration information including non-3GPP access without NAS allowed indication and non-3GPP access preference, the UE may update the stored information (e.g., non-3GPP access without NAS allowed indication and non-3GPP access preference).

When the received message does not include non-3GPP access without NAS allowed indication or when the non-3GPP access without NAS allowed indication indicates that non-3GPP access without NAS is not allowed, the UE may determine not to use non-3GPP access without NAS.

When the received message includes non-3GPP access preference, the UE may store the included mode.

The UE may determine which of legacy non-3GPP access and non-3GPP access without NAS to use, based on the stored mode.

For example, when legacy non-3GPP access first is included in non-3GPP access preference, the UE may use legacy non-3GPP access preferentially and use non-3GPP access without NAS only when NAS is not usable.

For example, when non-3GPP access without NAS first is included therein, the UE may use non-3GPP access without NAS preferentially and use legacy non-3GPP access only when NAS is not usable.

For example, when non-3GPP access without NAS only when roaming is included therein, the UE may use only non-3GPP access without NAS when roaming (i.e., may not use legacy non-3GPP access even when NAS is usable).

In step 207, when the UE has to transmit a PDU session establishment request through non-3GPP access, only when the UE has determined to use non-3GPP access without NAS in step 206, the UE may use non-3GPP access without NAS.

When the UE has determined to use non-3GPP access without NAS, the UE may transmit a PDU session establishment request message including multi access (MA) PDU session request indication and non-3GPP access without NAS capability to the AMF through 3GPP access.

When the UE has to transmit a PDU session establishment request through non-3GPP access, the UE may determine which of non-3GPP access without NAS and legacy non-3GPP access (e.g., non-3GPP access in which a connection with the AMF is present through a non-3GPP access point and an N3IWF) to use preferentially.

When receiving non-3GPP access preference from the AMF, the UE may perform a determination based on the mode included in the stored non-3GPP access preference.

When receiving a PDU session establishment request message including lightweight MA PDU session request indication and non-3GPP access without NAS capability from the UE, the AMF may transmit an SM context create request message including lightweight MA PDU session request indication, PDU session ID, S-NSSAI, and DNN to the SMF.

After receiving the SM context create request message, the SMF may receive, from the UDM, session management subscription data about the UE. The session management subscription data may include whether to allow the lightweight MA PDU session establishment. When the lightweight MA PDU session request indication is in the message received from the AMF, when the session management subscription data includes a lightweight MA PDU session establishment allowance indicator, the SMF may allow the PDU session establishment request. In this case, the SMF may include an N1 SM container (PDU session accept, lightweight MA PDU session proxy address (i.e., a proxy address with which the UE may perform a connection through non-3GPP access without NAS)) in a message transmitted to the AMF. The AMF may transmit the N1 SM container through the RAN to the UE.

When the lightweight MA PDU session request indication is in the message received from the AMF, when a lightweight MA PDU session establishment allowance indicator is not included in the session management subscription data, the SMF may include an N1 SM container (PDU session reject, cause=lightweight MA PDU session not allowed) in a message transmitted to the AMF. The AMF may transmit the N1 SM container through the RAN to the UE.

In step 208, when the configuration information received by the UE includes non-3GPP access without NAS only when roaming and when the UE is registered through non-3GPP access while roaming, the UE may transmit a deregistration request message through an N3IWF to the AMF through non-3GPP access, as described above in step 207.

After receiving the deregistration request in step 208, the AMF deregisters the UE over non-3GPP access.

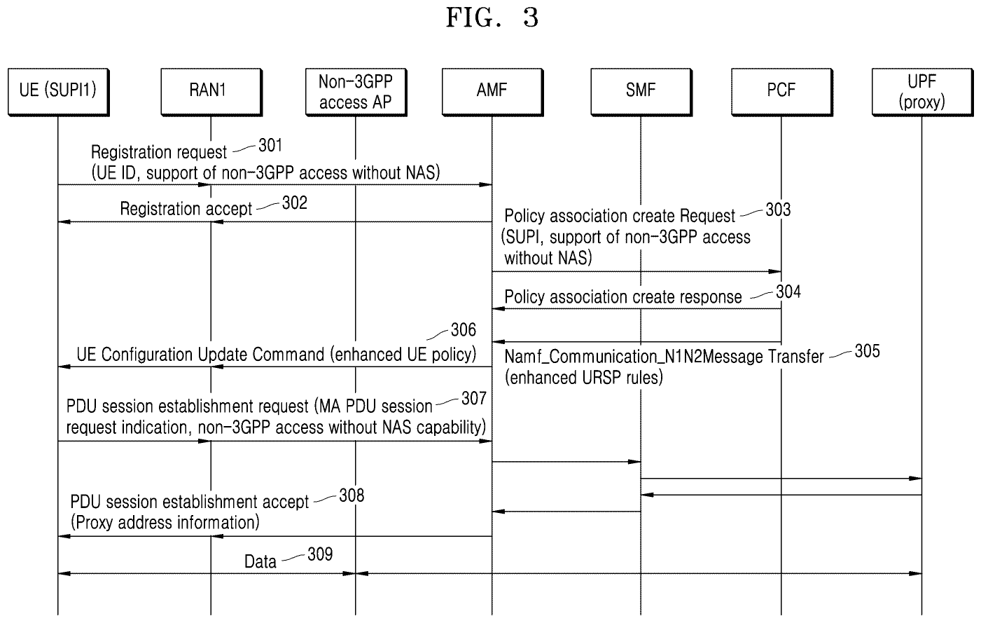

FIG. 3 illustrates a method of transmitting a URSP rule as terminal configuration information according to an embodiment.

Herein, instead of non-3GPP access without NAS, lightweight non-3GPP access, lightweight ATSSS, ATSSS with non-3GPP access without NAS, or the like may be used with the same meaning.

Referring to FIG. 3, in step 301, the UE may transmit a registration request message to the AMF through the RAN1.

When the UE supports non-3GPP access without a control signaling path (e.g., N2 interface or N1 interface), the UE may include an indicator indicating support (e.g., support of non-3GPP access without NAS) in the registration request message. However, the disclosure is not limited thereto.

The UE may include a UE ID based on a SUPI in a response request message.

In step 302, when the AMF receives the registration request message from the UE, the AMF may determine whether to allow UE registration based on subscription information of the UE.

The AMF may transmit a registration accept message to the UE through the RAN.

In step 303, the AMF may transmit a policy association establishment request message to the PCF.

When the registration request message received from the UE includes support of non-3GPP access without NAS, the AMF may include support of non-3GPP access without NAS in the policy association establishment request message transmitted to the PCF.

The policy association establishment request message transmitted by the AMF to the PCF may include, but is not limited to, a UE ID (e.g., SUPI).

In step 304, the PCF may transmit, to the AMF, a response message including the result (success or failure) of the UE policy association establishment request message received from the AMF.

In step 305, when the PCF accepts the UE policy association establishment in step 304, the PCF may transmit the UE policy through the AMF to the UE through a UE configuration update procedure.

When the UE supports non-3GPP access without NAS, the PCF may include the following information in a message transmitted to the AMF.

The following information may be transmitted in a transparent container (e.g., a UE policy container) transmitted to the UE.

Enhanced URSP rule: One or more URSP rules including information about application traffic (traffic descriptor) and corresponding route information (route selection descriptor) may be included therein. In this case, each URSP rule may have a value indicating a relative priority. In this case, the access type of the route selection descriptor may include, but is not limited to, one of non-3GPP access, 3GPP access, both 3GPP access and non-3GPP access, and both 3GPP access and non-3GPP access without NAS. One of non-3GPP access, 3GPP access, and both 3GPP access and non-3GPP access may be included in the access type of the route selection descriptor, and non-3GPP access without NAS allowed indication may be included for each URSP rule. The UE may transmit traffic through non-3GPP access without NAS only when the matching URSP rule includes non-3GPP access without NAS allowed indication.

The above information may be provided for each PLMN.

In step 306, the AMF may receive a message of step 305, and when a transparent container to be transmitted to the UE is in the message, the RAN may transmit the information to the UE through the RAN.

When the message received from the AMF through the RAN includes new configuration information (enhanced URSP rule), the UE may update the stored information.

When the UE receives a connection request from an upper layer, the UE may find a URSP rule matching the upper layer traffic based on the enhanced URSP rule received in step 306.

In step 307, when the route selection descriptor (RSD) of the matching URSP rule includes both 3GPP access and non-3GPP access without NAS (or lightweight MA PDU session), the UE may transmit a session establishment request message including MA PDU session request indication and non-3GPP access without NAS capability (or lightweight ATSSS capability) through 3GPP access to the UPF through the AMF, SMF and PCF.

According to an embodiment of the disclosure, when the UE receives a connection request from an upper layer, the UE may find a URSP rule matching the upper layer traffic based on the enhanced URSP rule received in operation 206. When the RSD of the matching URSP rule includes both 3GPP access and non-3GPP access (or lightweight MA PDU session) and when the corresponding URSP rule includes non-3GPP access without NAS allowed indication, the UE may transmit a session establishment request message including MA PDU session request indication and non-3GPP access without NAS capability (or lightweight ATSSS capability) through 3GPP access to the UPF through the AMF, SMF and PCF.

When the corresponding URSP rule does not include non-3GPP access without NAS allowed indication, the UE may transmit a session establishment request message including MA PDU session request indication.

In step 308, when receiving a session request message including MA PDU session request indication and non-3GPP access without NAS capability from the AMF, the SMF may transmit a message including a proxy address (e.g., an IP address and a port number or a fully qualified domain name (FQDN)) to the UE.

In step 309, when the received message includes a proxy address, the UE may transmit application traffic through the corresponding proxy.

When receiving a PDU session establishment request message including lightweight MA PDU session request indication and non-3GPP access without NAS capability from the UE, the AMF may transmit an SM context create request message including lightweight MA PDU session request indication, PDU cession ID, S-NSSAI, and DNN to the SMF.

After receiving the SM context create request message, the SMF may receive, from the UDM, session management subscription data about the UE. The session management subscription data may include whether to allow the lightweight MA PDU session establishment. When the lightweight MA PDU session request indication is in the message received from the AMF, when the session management subscription data includes a lightweight MA PDU session establishment allowance indicator, the SMF may allow the PDU session establishment request. In this case, the SMF may include an N1 SM container (PDU session accept, lightweight MA PDU session proxy address (i.e., a proxy address with which the UE may perform a connection through non-3GPP access without NAS)) in a message transmitted to the AMF. The AMF may transmit the N1 SM container through the RAN to the UE according to an embodiment of the disclosure.

When the lightweight MA PDU session request indication is in the message received from the AMF, when a lightweight MA PDU session establishment allowance indicator is not included in the session management subscription data, the SMF may include an N1 SM container (PDU session reject, cause=lightweight MA PDU session not allowed) in a message transmitted to the AMF. The AMF may transmit the N1 SM container through the RAN to the UE according to an embodiment.

Herein, the terminal (or UE) may include a transceiver, a memory, and a processor. The processor, the transceiver, and the memory of the UE may operate according to the operating method of the UE described above.

However, the components of the UE are not limited thereto. For example, the UE may include more components or fewer components than the above components. The processor, the transceiver, and the memory may be implemented in the form of a single chip.

The transceiver may collectively refer to a receiver of the UE and a transmitter of the UE and may transmit/receive signals to/from a base station or a network entity. The signals transmitted/received to/from the base station may include control information and data. For this purpose, the transceiver may include a radio frequency (RF) transmitter for up-converting and amplifying a transmitted signal and an RF receiver for low-noise-amplifying and down-converting a received signal.

However, this is merely an example of the transceiver, and the components of the transceiver are not limited to the RF transmitter and the RF receiver. The transceiver may include a wired/wireless transceiver and may include various components for transmitting/receiving signals. The transceiver may receive a signal through a wireless channel and output the received signal to the processor and may transmit a signal output from the processor through a wireless channel. The transceiver may receive a communication signal and output the communication signal to the processor and may transmit a signal output from the processor to a network entity through a wired/wireless network.

The memory may store at least one program, data, and instructions necessary for the operation of the UE. The memory may store control information or data included in the signal obtained by the UE. The memory may include a storage medium or a combination of storage media such as read only memory (ROM), random access memory (RAM), hard disk, compact disc (CD)-ROM, and digital versatile disc (DVD).

The processor may control a series of processes such that the UE may operate according to an embodiment of the disclosure described above. The processor may include one or more processors. For example, the processor may include a communication processor (CP) for performing control for communication and an application processor (AP) for controlling an upper layer such as an application program. The processor may be implemented by executing the instructions or codes of the program stored in the memory.

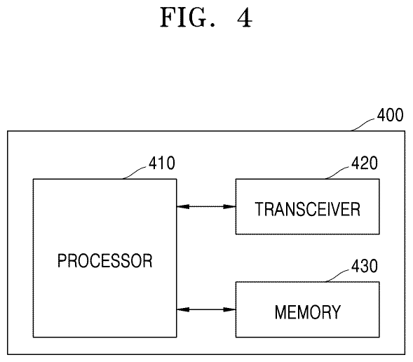

FIG. 4 is a diagram illustrating an internal structure of a UE, according to an embodiment of the disclosure.

Referring to FIG. 4, a UE 400 may include a processor 410, a transceiver 420, and a memory 430. According to the above communication method of the UE, the processor 410, the transceiver 420, and the memory 430 of the UE may operate. However, elements of the UE are not limited thereto. For example, the UE may include more elements or fewer elements than the afore-described elements. Furthermore, the processor 410, the transceiver 420, and the memory 430 may be implemented as one chip.

The processor 410 may control a series of processes to allow the UE to operate according to the above embodiment. The processor 410 may perform only some operations in the above embodiment. However, the disclosure is not limited thereto, and the processor 410 may control all processes so that the UE operates according to all or part of the above embodiment.

The transceiver 420 may transmit and receive a signal to and from a base station. The signal may include control information and data. To this end, the transceiver 420 may include an RF transmitter for up-converting and amplifying a frequency of a transmitted signal, and an RF receiver for low-noise amplifying and down-converting a frequency of a received signal. However, this is merely an example of the transceiver 420, and elements of the transceiver 420 are not limited to the RF transmitter and RF receiver.

Also, the transceiver 420 may receive a signal through a wireless channel and may output a signal to the processor 410, and may transmit a signal output from the processor 410 through the wireless channel.

The memory 430 may store programs and data necessary for operations of the UE. Also, the memory 430 may store control information or data included in a signal obtained by the UE. The memory 430 may include a storage medium such as a read-only memory (ROM), a random-access memory (RAM), a hard disk, a compact disk (CD)-ROM, or a digital versatile disk (DVD), or a combination thereof. Also, the memory 430 may include a plurality of memories.

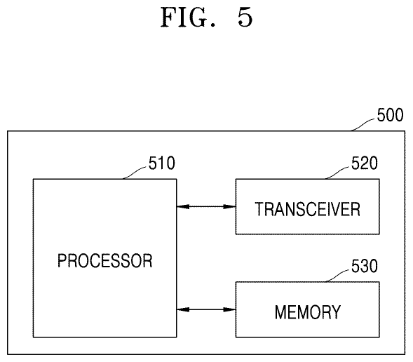

FIG. 5 is a diagram illustrating an internal structure of a base station, according to an embodiment of the disclosure.

Referring to FIG. 5, a base station may include a processor 510, a transceiver 520, and a memory 530. According to the communication method of the base station, the processor 510, the transceiver 520, and the memory 530 may operate. However, elements of the base station are not limited thereto. For example, the base station may include more or fewer elements than those illustrated in FIG. 11. In addition, the processor 510, the transceiver 520, and the memory 530 may be implemented as one chip. In an embodiment, the base station may include entities included in the base station and a core network, for example, an AMF, an SMF, and a UPF.

The processor 510 may control a series of processes to allow the base station to operate according to the above embodiment. The processor 510 may perform only some operations in the above embodiment. However, the disclosure is not limited thereto, and the processor 510 may control all processes so that the base station operates according to all or part of the above embodiment.

The transceiver 520 may transmit and receive a signal to and from a UE. The signal may include control information and data. To this end, the transceiver 520 may include an RF transmitter for up-converting and amplifying a frequency of a transmitted signal, and an RF receiver for low-noise amplifying and down-converting a frequency of a received signal. However, this is merely an example of the transceiver 520, and elements of the transceiver 520 are not limited to the RF transmitter and RF receiver.

Also, the transceiver 520 may receive a signal through a wireless channel and may output a signal to the processor 510, and may transmit a signal output from the processor 510 through the wireless channel.

The memory 530 may store programs and data necessary for operations of the base station. Also, the memory 530 may store control information or data included in a signal obtained by the base station. The memory 530 may include a storage medium such as a ROM, a RAM, a hard disk, a CD-ROM, or a DVD, or a combination thereof. Also, the memory 530 may include a plurality of memories. In an embodiment, the memory 530 may store a program for backhaul information-based session management.

Herein, blocks in each flowchart and combinations of flowcharts may be performed by one or more computer programs including computer-executable instructions. The one or more computer programs may all be stored in a single memory or may be separately stored in a plurality of different memories.

All functions or operations described herein may be processed by a processor or a combination of processors. The processor or the combination of processors may include circuitry that performs processing, such as an AP, a CP, a graphical processing unit (GPU), a neural processing unit (NPU), a microprocessor unit (MPU), a system-on-chip (SoC), or an integrated chip (IC).

The processor may include various processing circuits and/or a plurality of processors. For example, the term “processor” as used herein, including in the claims, may include various processing circuits including at least one processor. In the at least one processor, one or more processors may be configured to individually and/or collectively perform various functions described herein in a distributed manner. As used herein, the “processor”, “at least one processor”, or “one or more processors” may be configured to perform various functions. However, these terms may cover, without limitation, a situation in which a processor may perform some of the functions and another processor or other processors may perform some others of the functions and a situation in which a single processor may perform all of the functions. The at least one processor may include a combination of processors that perform various functions of the described functions in a distributed manner and may execute program instructions to achieve or perform various functions.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a wireless communication system, the method comprising:
transmitting, to an access and mobility management function (AMF), a registration request message including information indicating that the UE supports a non-3rd generation partnership project (3GPP) access without non-access stratum (NAS);
receiving, from the AMF, user equipment route selection policy (URSP) rule information including a route selection descriptor associated with the non-3GPP access without NAS; and
transmitting, to the AMF, a session establishment request message including information on a capability of the non-3GPP access without NAS.

2. The method of claim 1, wherein the URSP rule information further includes a traffic descriptor corresponding to the route selection descriptor and a value of relative priority for the URSP rule information.

3. The method of claim 1, wherein the route selection descriptor includes access type information indicating both 3GPP access and non-3GPP access without NAS.

4. The method of claim 1, further comprising:
receiving, from the AMF, a session establishment accept message including proxy address information; and
transmitting an application traffic based on the proxy address information.

5. The method of claim 4, wherein the proxy address information includes at least one of an internet protocol (IP) address, a port number, and a fully qualified domain name (FQDN).

6. A method performed by an access and management function (AMF) in a wireless communication system, the method comprising:
receiving, from a user equipment (UE), a registration request message including information indicating that the UE supports a non-3rd generation partnership project (3GPP) access without non-access stratum (NAS);
transmitting, to the UE, user equipment route selection policy (URSP) rule information including a route selection descriptor associated with the non-3GPP access without NAS; and
receiving, from the UE, a session establishment request message including information on a capability of the non-3GPP access without NAS.

7. The method of claim 6, wherein the URSP rule information further includes a traffic descriptor corresponding to the route selection descriptor and a value of relative priority for the URSP rule information.

8. The method of claim 6, wherein the route selection descriptor includes access type information indicating both 3GPP access and non-3GPP access without NAS.

9. The method of claim 6, further comprising:
transmitting, to the UE, a session establishment accept message including proxy address information.

10. The method of claim 9, wherein the proxy address information includes at least one of an internet protocol (IP) address, a port number, and a fully qualified domain name (FQDN).

11. A user equipment (UE) in a wireless communication system, comprising:
a transceiver; and
a processor coupled to the transceiver, and configured to:
transmit, to an access and mobility management function (AMF) via the transceiver, a registration request message including information indicating that the UE supports a non-3rd generation partnership project (3GPP) access without non-access stratum (NAS),
receive, from the AMF via the transceiver, user equipment route selection policy (URSP) rule information including a route selection descriptor associated with the non-3GPP access without NAS, and
transmit, to the AMF via the transceiver, a session establishment request message including information on a capability of the non-3GPP access without NAS.

12. The method of claim 11, wherein the URSP rule information further includes a traffic descriptor corresponding to the route selection descriptor and a value of relative priority for the URSP rule information.

13. The method of claim 11, wherein the route selection descriptor includes access type information indicating both 3GPP access and non-3GPP access without NAS.

14. The method of claim 11, wherein the processor is configured to:
receive, from the AMF via the transceiver, a session establishment accept message including proxy address information, and
transmit, via the transceiver, an application traffic based on the proxy address information.

15. The method of claim 14, wherein the proxy address information includes at least one of an internet protocol (IP) address, a port number, and a fully qualified domain name (FQDN).

16. An access and management function (AMF) in a wireless communication system, comprising:
a transceiver; and
a processor coupled to the transceiver, and configured to:
receive, from a user equipment (UE) via the transceiver, a registration request message including information indicating that the UE supports a non-3rd generation partnership project (3GPP) access without non-access stratum (NAS),
transmit, to the UE via the transceiver, user equipment route selection policy (URSP) rule information including a route selection descriptor associated with the non-3GPP access without NAS, and
receive, from the UE via the transceiver, a session establishment request message including information on a capability of the non-3GPP access without NAS.

17. The method of claim 16, wherein the URSP rule information further includes a traffic descriptor corresponding to the route selection descriptor and a value of relative priority for the URSP rule information.

18. The method of claim 16, wherein the route selection descriptor includes access type information indicating both 3GPP access and non-3GPP access without NAS.

19. The method of claim 16, wherein the processor is configured to:
transmit, to the UE via the transceiver, a session establishment accept message including proxy address information.

20. The method of claim 19, wherein the proxy address information includes at least one of an internet protocol (IP) address, a port number, and a fully qualified domain name (FQDN).
